(19) United States
(12) Patent Application Publication
(10) Pub. No.: US 2022/0349756 A1
(43) Pub. Date: Nov. 3, 2022

(54) SUNLIGHT INFORMATION PROVISION SYSTEM, INFORMATION PROCESSING DEVICE, AND SUNLIGHT INFORMATION PROVISION PROGRAM

(71) Applicant: NIHON UNISYS, LTD., Tokyo (JP)

(72) Inventor: Tomoyuki Okumura, Tokyo (JP)

(21) Appl. No.: 17/763,032

(22) PCT Filed: Jul. 29, 2020
(86) PCT No.: PCT/JP2020/029025

§ 371 Date: Mar. 23, 2022

(30) Foreign Application Priority Data
Sep. 25, 2019 (JP) 2019-173926

(51) Int. Cl. G01J 5/03; G01J 5/02; G01W 1/12

(52) U.S. Cl. CPC G01J 5/03; G01J 5/027; G01J 5/0275; G01W 1/12

(57) ABSTRACT

An object is a sunlight information provision system that allows a user to easily obtain more detailed sunlight information. A storage unit that stores date-and-time information, location information, and sunlight intensity information that is information regarding sunlight intensity at date and time indicated by the date-and-time information and location indicated by the location information in association with each other; a date-and-time information acquisition unit that acquires the date-and-time information; a location information acquisition unit that acquires the location information; a direction information acquisition unit that acquires the direction information; a first calculation unit that calculates the sunlight intensity information associated with sunlight inquiry information including the date-and-time information acquired by the date-and-time information acquisition unit, the location information acquired by the location information acquisition unit, and the direction information acquired by the direction information acquisition unit; a second calculation unit that calculates direction-specific sunlight intensity information by using a result of calculation of the first calculation unit; and a presentation unit that presents the direction-specific sunlight intensity information calculated by the second calculation unit to a user.

### TECHNICAL FIELD

The present invention relates to a sunlight information provision system, an information processing apparatus, and a sunlight information provision program.

### BACKGROUND ART

Recently, the influence of sunlight (for example, ultraviolet light, visible light, and infrared light) on the human body and living environment has been known, and attention has started to be drawn to a sunlight irradiation amount (for example, an ultraviolet light irradiation amount and an insolation amount). For example, in an exposure amount estimation system described in JP 5524741 B2, positional information indicating a position and environmental information indicating an amount of an exposure target such as ultraviolet light present at the position are stored in an environmental information storage unit in association with each other, an exposure amount is estimated on the basis of the environmental information acquired from the environmental information storage unit and an exposure rate determined according to an action or the like of the user, and a numerical value of the estimated exposure amount is provided to the user.

### CITATION LIST

### Patent Literature

Patent Literature 1: JP 5524741 B2

### SUMMARY OF INVENTION

### Technical Problem

Incidentally, in the exposure amount estimation system described in JP 5524741 B2, the exposure amount is estimated using the environmental information (airborne pollen amount, ultraviolet light amount, aerosol amount) specified by the positional information stored in the environmental information storage unit, but there is a problem that the user who receives information provision cannot easily obtain more detailed information with the environmental information specified by the positional information.

For example, in the real world, a part or a location where the energy intensity such as the ultraviolet light irradiation amount or the insolation amount is desired to be known is not necessarily a horizontal plane or a plane perpendicular to the sunlight, but varies. In order to know the energy intensity of such various parts and locations, it is conceivable to calculate the energy intensity on the actual irradiation surface using trigonometric functions or the like from the horizontal plane or the energy intensity perpendicular to the sunlight. However, since the energy intensity from the real sky scattered and reflected by an atmospheric component differs for each direction, there is a problem that sufficient accuracy cannot be obtained by calculation using trigonometric functions or the like.

The present invention has been made to solve the above problems, and an object of the present invention is to provide a sunlight information provision system that enables a user to easily obtain more detailed sunlight information.

### Solution to Problem

In order to achieve the object described above, the present invention is a sunlight information provision system including: a storage unit that stores date-and-time information that is information regarding date and time, location information that is information regarding a location, and sunlight intensity information that is information regarding sunlight intensity at the date and time indicated by the date-and-time information and location indicated by the location information in association with each other; a date-and-time information acquisition unit that acquires the date-and-time information; a location information acquisition unit that acquires the location information; a direction information acquisition unit that acquires the direction information; a first calculation unit that calculates the sunlight intensity information associated with sunlight inquiry information including the date-and-time information acquired by the date-and-time information acquisition unit, the location information acquired by the location information acquisition unit, and the direction information acquired by the direction information acquisition unit; a second calculation unit that calculates direction-specific sunlight intensity information by using a result of calculation of the first calculation unit; and a presentation unit that presents the direction-specific sunlight intensity information calculated by the second calculation unit to a user.

### Advantageous Effects of Invention

According to the present invention, it is possible to provide a sunlight information provision system that enables a user to easily obtain more detailed sunlight information.

### BRIEF DESCRIPTION OF DRAWINGS

FIG. 1 is a block diagram illustrating a configuration of a sunlight information provision system according to Example 1 of the present invention.

FIG. 2 is a diagram explaining a sunlight irradiation direction.

FIG. 3 is a diagram explaining sunlight emitted to an irradiation surface A, which is a surface parallel to the ground.

FIG. 4 is a diagram explaining sunlight emitted to an irradiation surface B, which is a surface forming an angle of 30° with the ground.

FIG. 5 is a diagram explaining sunlight emitted to an irradiation surface C, which is a surface forming an angle of 90° with the ground.

FIG. 6 is a diagram explaining sunlight reflected by an irradiation surface E and emitted to an irradiation surface D.

FIG. 7 is diagrams explaining an example of how to obtain the spectral reflectance of another irradiation surface, FIG. 7(a) is a diagram illustrating a status in which sunlight directly received by the irradiation surface E is measured, and FIG. 7(b) is a diagram illustrating a status in which reflected light by the irradiation surface E is measured.

FIG. 8 is a diagram explaining light incident on an irradiation surface within reflected light from another irradiation surface.

FIG. 9 is a diagram illustrating an example of information stored in a storage unit 13 illustrated in FIG. 1.

FIG. 10 is a flowchart illustrating an operation of a sunlight information provision system 10 illustrated in FIG. 1.

FIG. 11 is a block diagram illustrating a configuration of a sunlight information provision system according to Example 2 of the present invention.

FIG. 12 is a flowchart illustrating an operation of a sunlight information provision system 100 illustrated in FIG. 11.

FIG. 13 is a graph illustrating spectral irradiance.

FIG. 14 is a diagram illustrating an estimation condition regarding temperature rise of a material to be irradiated.

FIG. 15 is a diagram illustrating an example of estimation of a temperature rise after one hour according to materials.

FIG. 16(a) is a graph illustrating an example of spectral irradiation intensity from each direction on a sidewalk. FIG. 16(b) is a graph illustrating an example of spectral reflectance on a sidewalk.

FIG. 17(a) is a graph illustrating an example of spectral irradiation intensity from each direction on a sidewalk. FIG. 17(b) is a graph illustrating an example of spectral reflectance on a sidewalk.

FIG. 18(a) is a graph illustrating an example of spectral irradiation intensity from each direction on a sidewalk. FIG. 18(b) is a graph illustrating an example of spectral reflectance on a sidewalk.

FIG. 19 is a block diagram illustrating a configuration of a sunlight information provision system according to Example 8 of the present invention.

FIG. 20 is a block diagram illustrating a configuration of a sunlight information provision system according to Example 9 of the present invention.

FIG. 21 is a block diagram illustrating a configuration of a sunlight information provision system according to Example 10 of the present invention.

FIG. 22 is a block diagram illustrating a configuration of a sunlight information provision system according to Example 11 of the present invention.

### DESCRIPTION OF EMBODIMENTS

Hereinafter, the sunlight information provision system according to the present invention will be described in detail with reference to the drawings. Note that embodiments described below are preferred specific examples of the system according to the present invention, and various limitations conforming to general hardware and software configurations may be applied, but the technical scope of the present invention is not limited to such aspects unless otherwise specified to limit the present invention. In addition, components in the embodiments described below can be replaced with existing components and the like as appropriate, and various variations including combinations with other existing components are possible. Therefore, the description of the embodiments described below does not limit the contents of the invention described in the claims.

Note that, in the examples described below, the present invention is applied to the sunlight information provision system, and the system in which information regarding sunlight, for example, an insolation amount is provided to the user will be described; however, the present invention may provide the user with individual pieces of information such as ultraviolet light, infrared light, visible light, or other electromagnetic waves included in the sunlight. In addition, in the examples described below, the sunlight intensity is also referred to as insolation intensity.

### Example 1

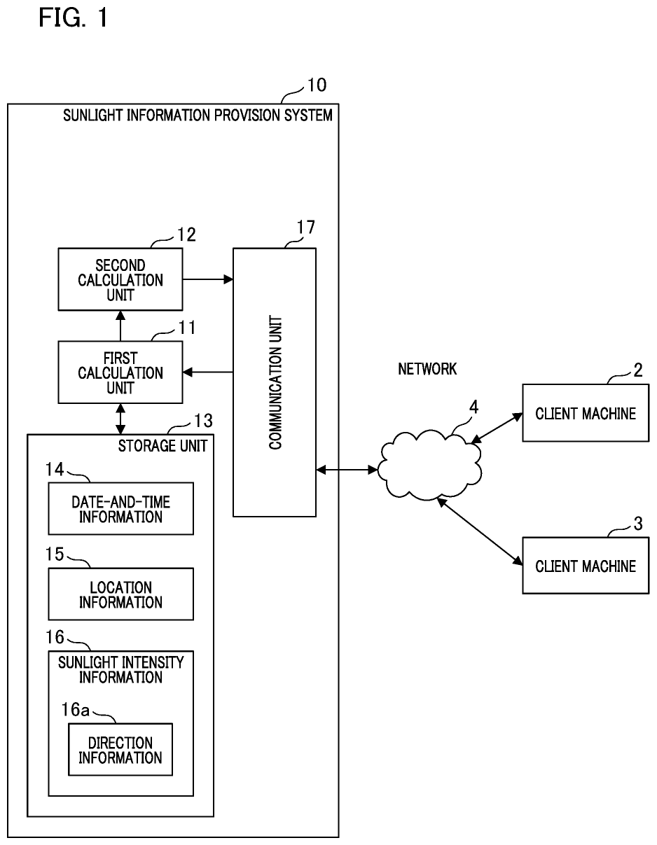

FIG. 1 is a block diagram illustrating a configuration of a sunlight information provision system according to Example 1 of the present invention. The sunlight information provision system 10 of the present example is, for example, a server machine including a computer.

As illustrated in FIG. 1, the sunlight information provision system 10 includes a storage unit 13 that stores sunlight intensity information 16 described below in detail and various other types of information, a communication unit 17 that performs communication, a first calculation unit 11 that calculates the sunlight intensity information 16 associated with sunlight inquiry information received via the communication unit 17, and a second calculation unit 12 that calculates direction-specific sunlight intensity information using the result of calculation of the first calculation unit 11. The communication unit 17 communicates, for example, with the outside. The sunlight inquiry information includes date-and-time information 14, location information 15, and direction information 16a indicating a direction in which an irradiation surface receiving irradiation of sunlight, that is, insolation faces. The direction-specific sunlight intensity information is the intensity of the sunlight received by the irradiation surface indicated by the direction information 16a at the date and time indicated by the date-and-time information 14 and the location indicated by the location information 15, and the communication unit 17 transmits the direction-specific sunlight intensity information indicating the direction-specific sunlight intensity calculated by the second calculation unit 12 to the transmission source of the sunlight inquiry information. Each configuration illustrated in FIG. 1 may be configured by hardware. In addition, each configuration illustrated in FIG. 1 can also be realized by the sunlight information provision system 10 executing a program, and the storage unit 13 may store the program executed by the sunlight information provision system 10. The storage unit 13 includes a volatile storage apparatus and a nonvolatile storage apparatus depending on the use of data.

Note that, in the sunlight information provision system 10, the communication unit 17 may be configured to transmit the sunlight intensity information calculated by the first calculation unit 11 to the transmission source of the sunlight inquiry information. In this case, a client machine 2 or 3 may have a configuration corresponding to the function of the second calculation unit 12. That is, the present invention is a sunlight information provision system including a server machine and a client machine connected via a network, in which the server machine may be configured to include the storage unit 13 that stores the date-and-time information 14 that is information regarding date and time, the location information 15 that is information regarding a location, and the sunlight intensity information 16 that is information regarding sunlight intensity at the date and time indicated by the date-and-time information and the location indicated by the location information in association with each other, a first communication unit that communicates with a client machine, and the first calculation unit 11 that calculates the sunlight intensity information 16 associated with sunlight inquiry information input via the first communication unit, in which the first communication unit transmits the sunlight intensity information 16 calculated by the first calculation unit 11 to the client machine, the client machine includes a second communication unit that communicates with a server machine 1 and a second calculation unit (a configuration corresponding to the function of the second calculation unit 12) that calculates the direction-specific sunlight intensity information using the sunlight intensity information 16 input via the second communication unit, the second communication unit (a configuration corresponding to the function of the second calculation unit 12) transmits the sunlight inquiry information to the server machine, and the sunlight inquiry information includes the date-and-time information 14, the location information, and the direction information 16a indicating the direction in which the irradiation surface receiving the irradiation of the sunlight faces. Note that the client machine and the server machine may be in the same terminal apparatus without a network. In this case, the client machine and the server machine may be the same apparatus, or the client machine and the server machine may, for example, be configured to be connected by a bus. In a case where the client machine and the server machine are the same apparatus, connecting the client machine and the server machine may mean that a program for realizing the function as the client machine and a program for realizing the function as the server machine exchange data via memory or the like.

The storage unit 13 stores the date-and-time information 14 that is information regarding date and time, the location information 15 that is information regarding a location, and the sunlight intensity information 16 that is information regarding sunlight intensity at the date and time indicated by the date-and-time information 14 and the location indicated by the location information 15 in association with each other.

The communication unit 17 of the sunlight information provision system 10 is connected to the network 4 such as the Internet. The client machines 2 and 3 used by the user are connected to the network 4, and the client machines 2 and 3 communicate with the sunlight information provision system 10 via the network 4.

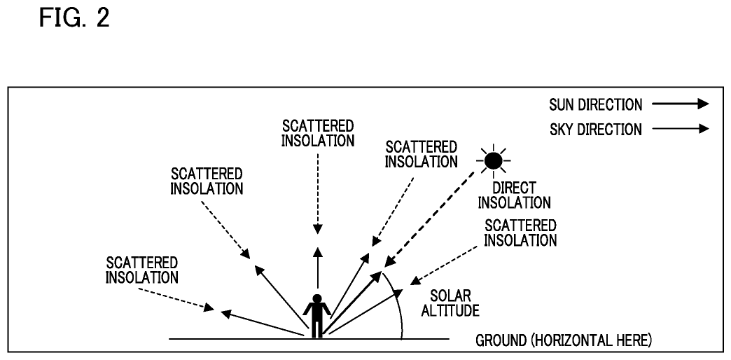

The sunlight inquiry information is transmitted from the client machine 2 or the client machine 3 to the sunlight information provision system 10 via the network 4. The sunlight inquiry information includes the date-and-time information 14, the location information 15, and the direction information 16a indicating a direction in which an irradiation surface receiving irradiation of sunlight faces. The direction indicated by the direction information 16a is a direction orthogonal to the surface on which the irradiation surface receiving the irradiation of the sunlight extends. The direction information 16a will be described below with reference to FIGS. 2 to 5. The result of calculation by the calculation unit 11 is transmitted from the sunlight information provision system 10 to the client machine 2 or the client machine 3, which is the transmission source of the sunlight inquiry information, via the network 4.

The first calculation unit 11 calculates the sunlight intensity information 16 to be described in detail below using the date-and-time information and the location information included in the sunlight inquiry information. The second calculation unit 12 uses the result of calculation by the first calculation unit 11 to calculate the direction-specific sunlight intensity information that is information including the intensity of the sunlight received by the irradiation surface indicated by the direction information 16a. The communication unit 17 transmits the direction-specific sunlight intensity information indicating the direction-specific sunlight intensity calculated by the second calculation unit 12 to the client machine 2 or the client machine 3, which is the transmission source of the sunlight inquiry information, via the network 4.

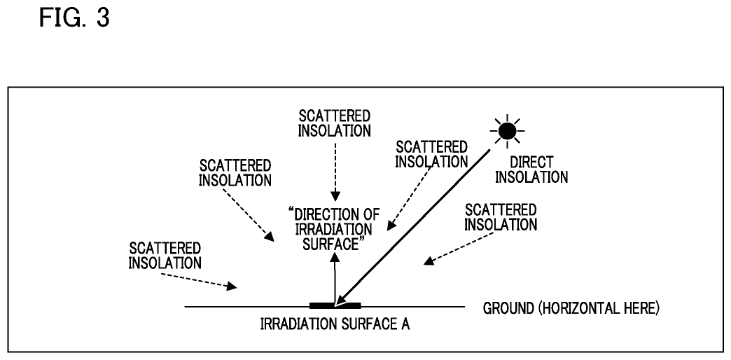

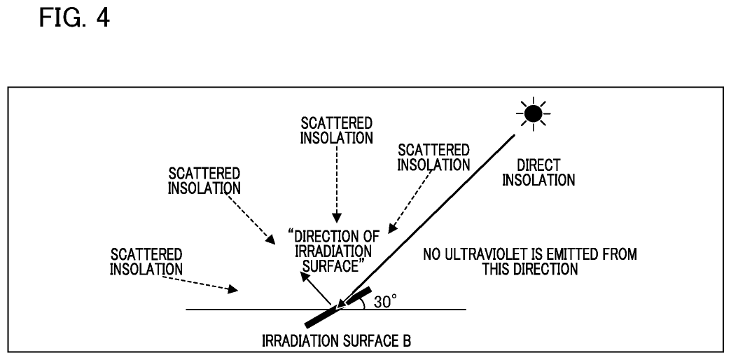

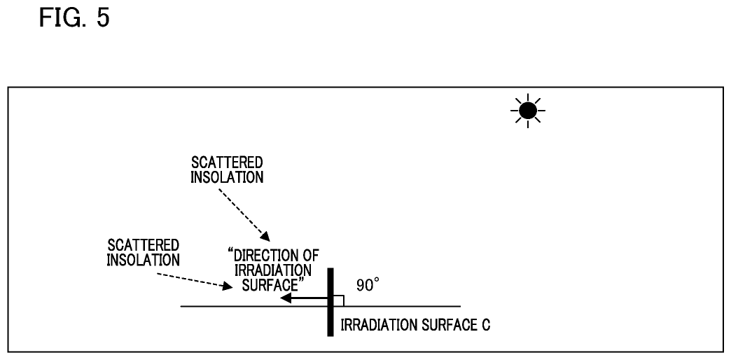

The direction information 16a will be described below. FIG. 2 is a diagram explaining a sunlight irradiation direction. FIG. 3 is a diagram explaining sunlight emitted to the irradiation surface A, which is a surface parallel to the ground. FIG. 4 is a diagram explaining sunlight emitted to the irradiation surface B, which is a surface forming an angle of 30° with the ground. FIG. 5 is a diagram explaining sunlight emitted to the irradiation surface C, which is a surface forming an angle of 90° with the ground. In FIGS. 3, 4, and 5, the direction in which the irradiation surface receiving irradiation of the sunlight faces, that is, the direction indicated by the direction information 16a is referred to as the “direction of irradiation surface”.

As illustrated in FIG. 2, the sunlight emitted onto the earth includes direct insolation emitted from the direction of the sun and scattered insolation emitted from a direction other than the direction of the sun. Scattered insolation is emitted to the irradiation surface from the entire sky. The irradiation surface A, which is a surface parallel to the ground, is irradiated with scattered insolation and direct insolation from the entire sky as illustrated in FIG. 3.

In addition, the irradiation surface B forming an angle of 30° with the ground is irradiated with scattered insolation and direct insolation from the direction in which the irradiation surface B faces in the entire sky as illustrated in FIG. 4. In addition, the irradiation surface C forming an angle of 90° with the ground is not irradiated with direct insolation since the direction of the sun is the back side of the irradiation surface C as illustrated in FIG. 5, and is irradiated with scattered insolation from the direction in which the irradiation surface C faces in the entire sky. In addition, in addition to scattered insolation and direct insolation that are directly emitted to the irradiation surface, the sunlight emitted to the irradiation surface includes sunlight that is reflected by the ground and the like and emitted to the irradiation surface.

As can be seen with reference to FIGS. 3, 4, and 5, the intensity of the emitted sunlight greatly varies depending on the direction in which the irradiation surface faces. Therefore, in the present example, the direction-specific sunlight intensity information different for each direction in which the irradiation surface faces is calculated and provided to the client machine 2 or the client machine 3, which is the transmission source of the sunlight inquiry information.

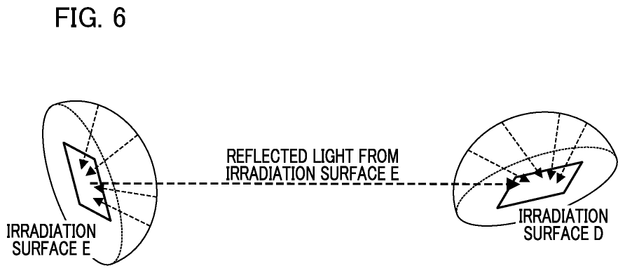

Note that, in the present example, in addition to scattered insolation and direct insolation, it is also possible to consider sunlight reflected by another irradiation surface such as the ground and a wall surface and emitted to the irradiation surface. This point will be described with reference to FIG. 6. FIG. 6 is a diagram explaining sunlight reflected by the irradiation surface E and emitted to the irradiation surface D.

In the actual environment, the irradiation amount of the sunlight received by the irradiation surface D includes not only the sunlight (direct insolation and scattered insolation) directly received by the irradiation surface D, but also the sunlight (reflected light) obtained by reflecting the sunlight (direct insolation and scattered insolation) on another irradiation surface (irradiation surface E) such as the ground and a wall surface. In the present example, by including the intensity of the reflected light reflected by another irradiation surface in the intensity of the sunlight received by the irradiation surface, the accuracy of obtaining the intensity of the sunlight received by the irradiation surface can be further improved.

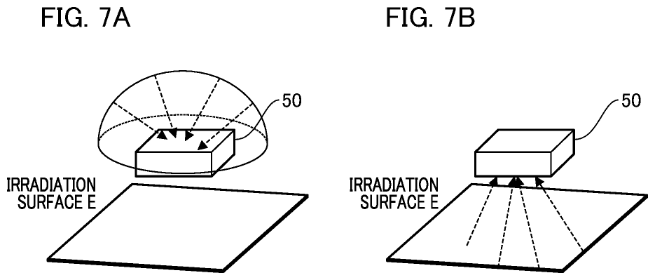

Normally, the reflectance of another irradiation surface is used for calculating the reflected light by another irradiation surface. For the reflectance of a material surface, generally, a reflectance based on a typical specific wavelength is used, but in order to accurately calculate the energy intensity, it is desirable to calculate the energy intensity using a spectral reflectance. Here, how to obtain the spectral reflectance of another irradiation surface will be described with reference to FIG. 7.

FIG. 7 is diagrams explaining an example of how to obtain the spectral reflectance of another irradiation surface, FIG. 7(a) is a diagram illustrating a status in which sunlight directly received by the irradiation surface E is measured, and FIG. 7(b) is a diagram illustrating a status in which reflected light by the irradiation surface E is measured. As illustrated in FIGS. 7(a) and 7(b), a measuring instrument 50 is used here. The measuring instrument 50 is a measuring instrument that functions as a spectral illuminometer. First, as illustrated in FIG. 7(a), the spectral illuminance from above the irradiation surface E, which is another irradiation surface, (the spectral illuminance of the sunlight emitted to the irradiation surface E) is measured using the measuring instrument 50. In addition, the spectral illuminance reflected by the irradiation surface E (the spectral illuminance of the reflected light of the sunlight reflected by the irradiation surface E) is measured using the measuring instrument 50. Using the obtained spectral illuminance from above the irradiation surface E and the spectral illuminance reflected by the irradiation surface E, the spectral reflectance of the irradiation surface E is obtained by Math. 1.

$$Spectral reflectance of irradiation surface E = \frac{Spectral illuminance reflected by irradition surface E}{Spectral illuminance from above irradiation surface E} \qquad [ Math . 1 ]$$

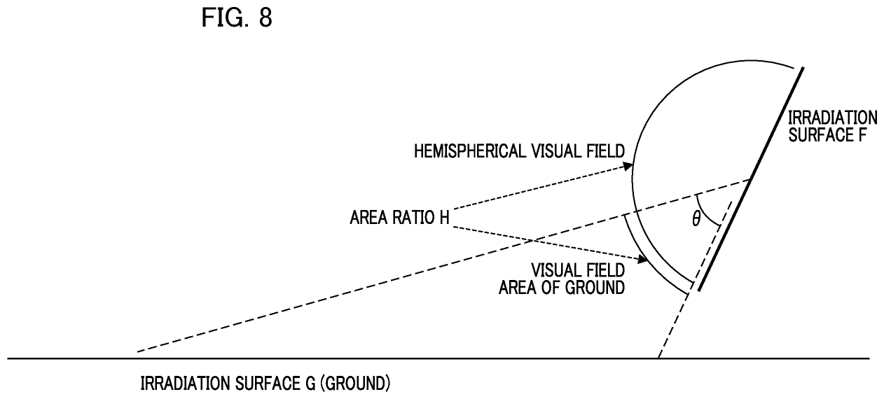

Next, calculation of the irradiation energy received by the irradiation surface using the spectral reflectance obtained by Math. 1 will be described. FIG. 8 is a diagram explaining light incident on an irradiation surface within reflected light from another irradiation surface. FIG. 8 illustrates a case where an irradiation surface G, which is another irradiation surface, is the ground, and takes into consideration the proportion of light incident on an irradiation surface F within reflected light from the irradiation surface G. The energy incident on the irradiation surface F from the irradiation surface G (ground) can be calculated by Math. 2.

Energy incident on irradiation surface F from irradiation surface G (ground)=Irradiation energy received by irradiation surface G×Reflectance×Area ratio H Math. 2

The irradiation energy received by the irradiation surface G in Math. 2 can be obtained, for example, by the method illustrated in FIG. 7(a). As the reflectance in Math. 2, for example, the spectral reflectance obtained by Math. 1 can be used. An area ratio H in Math. 2 can be obtained as described below with reference to FIG. 8. In FIG. 8, the visual field area of the ground (irradiation surface G) on the irradiation surface F is determined by an angle θ depending on the direction of the irradiation surface F. The angle θ that defines the visual field area of the irradiation surface G, which is the ground, is geometrically an angle formed by the irradiation surface F and the horizontal direction when the irradiation surface G is an ideal ground (horizontal). However, in practice, it is favorable to consider a topographic change or to consider that the reflected light incident on the irradiation surface F decreases and the contribution degree attenuates as the position of the irradiation surface G is farther from the irradiation surface F, and it is favorable to determine the angle θ according to the necessary accuracy.

The ratio of the visual field area of the ground on the irradiation surface F to the hemispherical area of the irradiation surface F is the area ratio H. In the present example, when the irradiation energy received by the irradiation surface F is obtained, the irradiation energy can be obtained with higher accuracy by adding the energy incident on the irradiation surface F obtained by Math. 2 to the irradiation energy by scattered insolation and direct insolation directly emitted onto the irradiation surface F. In addition, although the ground is taken into consideration as another irradiation surface in Math. 2, the irradiation energy received by the irradiation surface F can be obtained with higher accuracy by considering not only the reflected light by the ground but also all the other irradiation surfaces from which the reflected light can be incident on the irradiation surface F.

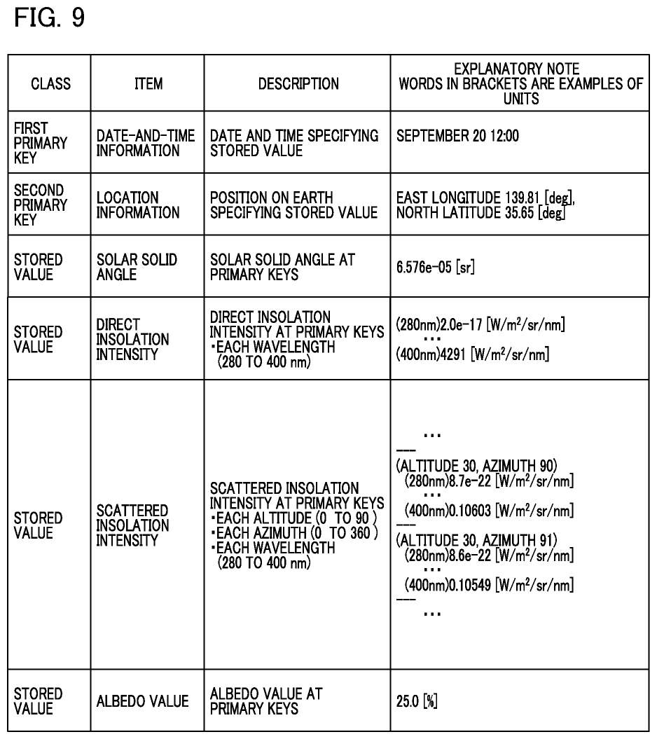

FIG. 9 is a diagram illustrating an example of information stored in the storage unit 13 illustrated in FIG. 1. The storage unit 13 stores the information illustrated in FIG. 9, for example, in a database format. The storage unit 13 stores the date-and-time information 14 as a first primary key. The date-and-time information 14 may include year, month, day, and time. The storage unit 13 stores the location information 15 as a second primary key. The location information 15 is information for specifying a position on the earth using, for example, east longitude and north latitude.

The storage unit 13 stores solar solid angles at the first primary key and the second primary key as the sunlight intensity information 16, which is a stored value. The storage unit 13 stores direct insolation intensity at the first primary key and the second primary key as the sunlight intensity information 16, which is a stored value. The storage unit 13 stores scattered insolation intensity at the first primary key and the second primary key as the sunlight intensity information 16, which is a stored value. The storage unit 13 stores an albedo value at the first primary key and the second primary key as the sunlight intensity information 16, which is a stored value. Note that the albedo value is a ratio of the reflected sunlight intensity to the emitted sunlight intensity. For example, in a region with the location information 15, the ground is soil and has a low albedo value when the date-and-time information 14 indicates date and time of summer, and the ground is a snow surface and has a high albedo value when the date-and-time information 14 indicates date and time of winter. For each value illustrated in FIG. 9, for example, an actual measurement value is collected and stored in the storage unit 13. The direction information 16a included in the sunlight intensity information 16 is included in the stored value illustrated in FIG. 9. The information included in the sunlight intensity information 16 includes, for example, a value calculated by solving the radiative transfer equation or a value calculated in the process of solving the radiative transfer equation.

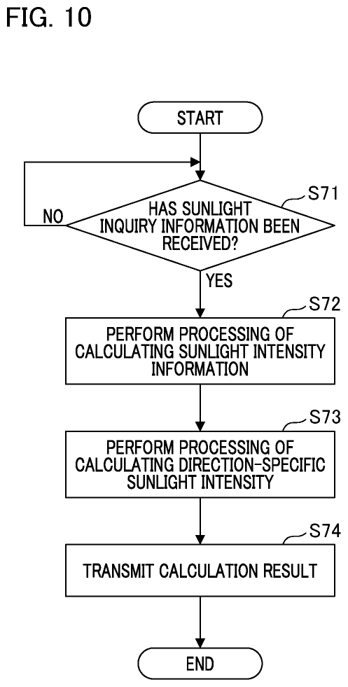

FIG. 10 is a flowchart illustrating an operation of the sunlight information provision system 10 illustrated in FIG. 1. In step S71, it is determined whether or not the sunlight inquiry information has been received from the client machine 2 or the client machine 3 via the network 4. When the sunlight inquiry information has been received (step S71: Yes), the processing proceeds to step S72, and when the sunlight inquiry information has not been received (step S71: No), the processing returns to step S71.

In step S72, on the basis of the sunlight inquiry information received in step S71, the sunlight intensity information 16, which is information including the intensity of the sunlight received at the location indicated by the location information 15 included in the sunlight inquiry information at the date and time indicated by the date-and-time information 14 included in the sunlight inquiry information, is calculated and stored in the storage unit 13. The sunlight intensity information 16 is calculated using, for example, the radiative transfer equation.

In step S73, by performing mathematical calculation using the direction information 16 as an input value with respect to the sunlight intensity information 16 calculated in step S72, the direction-specific sunlight intensity information, which is the sunlight intensity information received by the irradiation surface indicated by the direction information 16a at the location indicated by the location information 15 included in the sunlight inquiry information at the date and time indicated by the date-and-time information 14, is calculated.

In step S74, the direction-specific sunlight intensity information indicating the direction-specific sunlight intensity calculated in step S73 is transmitted to the client machine 2 or the client machine 3, which is the transmission source of the current sunlight inquiry information, via the network 4. The client machine 2 or the client machine 3 can obtain the direction-specific sunlight intensity information by simply transmitting the sunlight inquiry information including the date-and-time information 14, the location information 15, and the direction information 16a to the sunlight information provision system 10, and more detailed sunlight information can be easily obtained. The client machine 2 or the client machine 3 can provide various applications to the end user by using the direction-specific sunlight intensity information obtained from the sunlight information provision system 10.

### Example 2

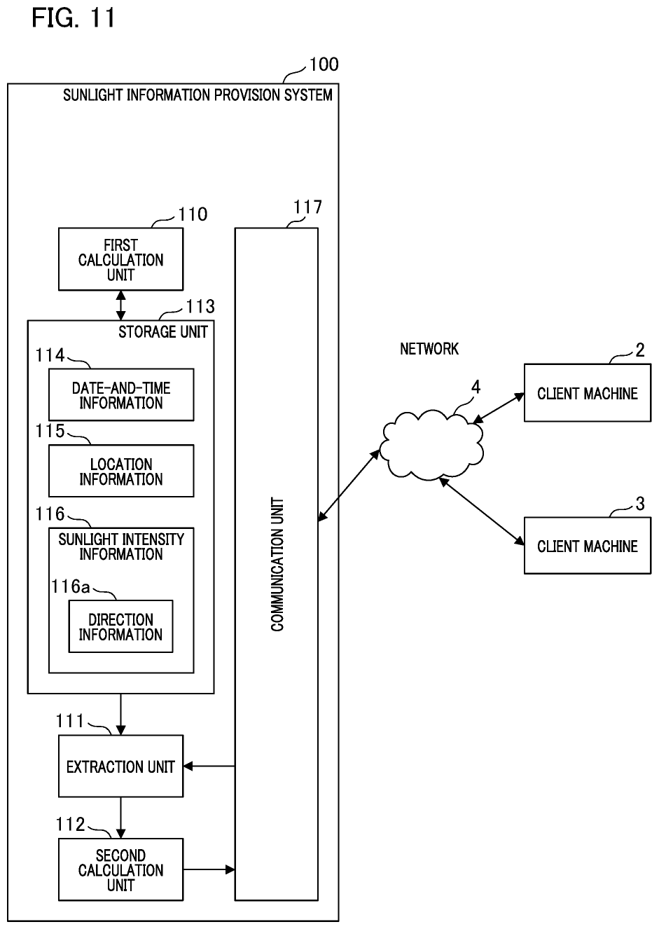

FIG. 11 is a block diagram illustrating a configuration of a sunlight information provision system according to Example 2 of the present invention. The sunlight information provision system 100 of the present example is, for example, a server machine including a computer.

As illustrated in FIG. 11, the sunlight information provision system 100 includes a first calculation unit 110 that calculates in advance sunlight intensity information 116 described below in detail using date-and-time information and location information, a storage unit 113 that stores the sunlight intensity information 116 calculated by the first calculation unit 110 and various other types of information, a communication unit 117 that performs communication, an extraction unit 111 that extracts from the storage unit 113 the sunlight intensity information 116 associated with sunlight inquiry information input via the communication unit 117, and a second calculation unit 112 that calculates direction-specific sunlight intensity information using the sunlight intensity information 116 extracted by the extraction unit 111. The communication unit 117 communicates, for example, with the outside. The sunlight inquiry information includes date-and-time information 114, location information 115, and direction information 116a. The direction-specific sunlight intensity information is information including the intensity of the sunlight received by the irradiation surface indicated by the direction information 116a at the date and time indicated by the date-and-time information 114 and the location indicated by the location information 115. The communication unit 117 transmits the direction-specific sunlight intensity information calculated by the second calculation unit 112 to the transmission source of the sunlight inquiry information. Each configuration illustrated in FIG. 11 may be configured by hardware. In addition, each configuration illustrated in FIG. 11 can also be realized by the sunlight information provision system 100 executing a program, and the storage unit 113 may store the program executed by the sunlight information provision system 100. The storage unit 113 includes a volatile storage apparatus and a nonvolatile storage apparatus depending on the use of data.

Note that, in the sunlight information provision system 100, the communication unit 117 may be configured to transmit the sunlight intensity information extracted by the extraction unit 111 to the transmission source of the sunlight inquiry information. In this case, the client machine 2 or 3 may have a configuration corresponding to the function of the second calculation unit 112. That is, the present invention is a sunlight information provision system including a server machine and a client machine connected via a network, in which the server machine may be configured to include the first calculation unit 110 that calculates the sunlight intensity information 116 that is information regarding sunlight intensity at the date and time indicated by the date-and-time information 114 that is information regarding date and time and the location indicated by the location information 115 that is information regarding a location, the storage unit 113 that stores the date-and-time information 114, the location information 115, and the sunlight intensity information 116 calculated by the first calculation unit 110 in association with each other, a first communication unit that communicates with the client machine, and the extraction unit 111 that extracts from the storage unit 113 the sunlight intensity information 116 associated with the sunlight inquiry information input via the first communication unit, in which the first communication unit transmits the sunlight intensity information 116 extracted by the extraction unit 111 to the client machine, the client machine includes a second communication unit that communicates with the server machine, and a second calculation unit (a configuration corresponding to the function of the second calculation unit 112) that calculates the direction-specific sunlight intensity information using the sunlight intensity information 116 input via the second communication unit, the second communication unit transmits the sunlight inquiry information to the server machine, and the sunlight inquiry information includes the date-and-time information 114, the location information 115, and the direction information 116a indicating the direction in which the irradiation surface receiving the irradiation of the sunlight faces.

The storage unit 113 stores the date-and-time information 114 that is information regarding date and time, the location information 115 that is information regarding a location, and the sunlight intensity information 116 (the sunlight intensity information 116 calculated by the first calculation unit 110) that is information regarding sunlight intensity at the date and time indicated by the date-and-time information 114 and the location indicated by the location information 115 in association with each other.

The communication unit 117 of the sunlight information provision system 100 is connected to the network 4 such as the Internet. The client machines 2 and 3 used by the user are connected to the network 4, and the client machines 2 and 3 communicate with the sunlight information provision system 100 via the network 4.

The sunlight inquiry information is transmitted from the client machine 2 or the client machine 3 to the sunlight information provision system 100 via the network 4. The sunlight inquiry information includes date-and-time information 114, location information 115, and direction information 116a. The direction-specific sunlight intensity information, which is a result of extraction by the extraction unit 112, is transmitted from the sunlight information provision system 100 to the client machine 2 or the client machine 3, which is the transmission source of the sunlight inquiry information, via the network 4.

Note that, in the present example, an example of the information stored in the storage unit 113 is the information illustrated in FIG. 9.

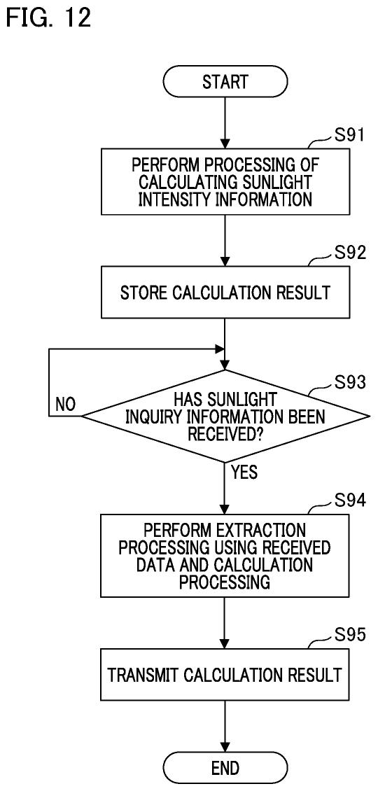

FIG. 12 is a flowchart illustrating an operation of the sunlight information provision system 100 illustrated in FIG. 11. In step S91, information included in the sunlight intensity information 116 at all dates and times and all locations is calculated using the date-and-time information and the location information. For calculation of the information included in the sunlight intensity information 116, for example, the radiative transfer equation is used. That is, the information included in the sunlight intensity information 116 includes, for example, a value calculated by solving the radiative transfer equation or a value calculated in the process of solving the radiative transfer equation. In step S92, the information included in the sunlight intensity information 116 calculated in step S91 is stored in the storage unit 113.

Subsequently, when the sunlight inquiry information from the client machine 2 or the client machine 3 has been received via the network 4 (step S93: Yes), the processing proceeds to step S94, and when the sunlight inquiry information has not been received (step S93: No), the processing returns to step S90. Note that the calculation of the information included in the sunlight intensity information 116 and the storage of the calculated information in the storage unit 13 may be completed before the processing of receiving the sunlight inquiry information from the client machine 2 or 3 is performed, or may be updated each time, for example, in a case where data of a region that has not been available until now can be newly obtained.

In step S94, the sunlight intensity information 116 is extracted from the storage unit 113 on the basis of the sunlight inquiry information included in the data received from the client machine 2 or the client machine 3. That is, the sunlight intensity information 116 corresponding to the date-and-time information 114 and the location information 115 included in the sunlight inquiry information is extracted from the storage unit 113. Furthermore, in step S94, by performing a mathematical calculation using the direction information 116a as an input value with respect to the value of the extracted sunlight intensity information 116, the direction-specific sunlight intensity information, which is information including the intensity of sunlight received by the irradiation surface indicated by the direction information 116a at the location indicated by the location information 15 included in the sunlight inquiry information at the date and time indicated by the date-and-time information 14, is calculated.

In step S95, the direction-specific sunlight intensity information calculated in step S94 is transmitted to the client machine 2 or the client machine 3, which is the transmission source of the current sunlight inquiry information, via the network 4. The client machine 2 or the client machine 3 can obtain the direction-specific sunlight intensity information by simply transmitting the sunlight inquiry information including the date-and-time information 114, the location information 115, and the direction information 116a to the sunlight information provision system 100, and more detailed sunlight information can be easily obtained. The client machine 2 or the client machine 3 can provide various applications to the end user by using the direction-specific sunlight intensity information obtained from the sunlight information provision system 100.

In addition, in the present example, since the sunlight intensity information 116 is calculated in advance, the response is faster than in the case where the sunlight intensity information is calculated after receiving the sunlight inquiry information from the client machine 2 or the client machine 3, and the direction-specific sunlight intensity information can be provided with higher immediacy.

### Example 3

<Calculation of Irradiation Heat Amount>

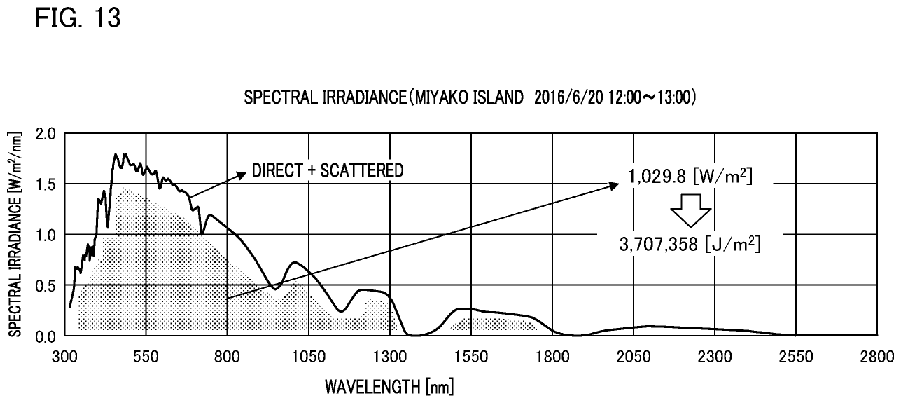

In the present example, in the configuration illustrated in FIG. 1, the sunlight information provision system 10 can calculate an irradiation heat amount. FIG. 13 is a graph illustrating spectral irradiance. In FIG. 13, the horizontal axis is the wavelength of light, and the vertical axis is spectral irradiance. FIG. 13 illustrates a result of calculating the energy intensity of the sky with respect to the irradiation surface by simulation and then calculating the heat amount emitted to the irradiation surface on the basis of Example 1 described above. In addition, FIG. 13 is an example of calculation of the heat amount received by the irradiation surface disposed on Miyako Island at 12:00 to 1300 on Jun. 20, 2016. According to the present example, the integrated value of the energy emitted to the irradiation surface is determined to be 1,029.8 [W/m²], and the heat amount received by the irradiation surface is determined to be 3,707,358 [J/m²].

According to the present example, it is possible to predict an irradiation heat amount received by a high-rise structure or the like and forests, which has been difficult to measure, and it is possible to utilize the prediction for defense design of a structure and a forest tree planting plan.

### Example 4

<Calculation of Irradiation Amount Emitted to Structures>

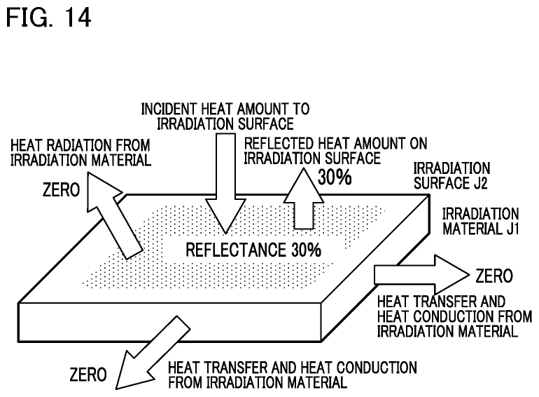

In the present example, in the configuration illustrated in FIG. 1, the sunlight information provision system 10 can predict a temperature rise according to the material to be irradiated (the material of an irradiation material having the irradiation surface) from the heat amount received by the irradiation surface, which is the result obtained in Example 3. In the present example, the prediction of the temperature rise of the irradiation surface will be described. FIG. 14 is a diagram illustrating an estimation condition regarding temperature rise of a material to be irradiated. As illustrated in FIG. 14, in the present example, it is assumed that sunlight is incident on an irradiation surface J2 of an irradiation material J1 and the reflectance of the irradiation surface J2 is 30%. In addition, it is assumed that the heat radiation from the irradiation material J1 is zero. In addition, it is assumed that the heat transfer and heat conduction from the irradiation material J1 are zero.

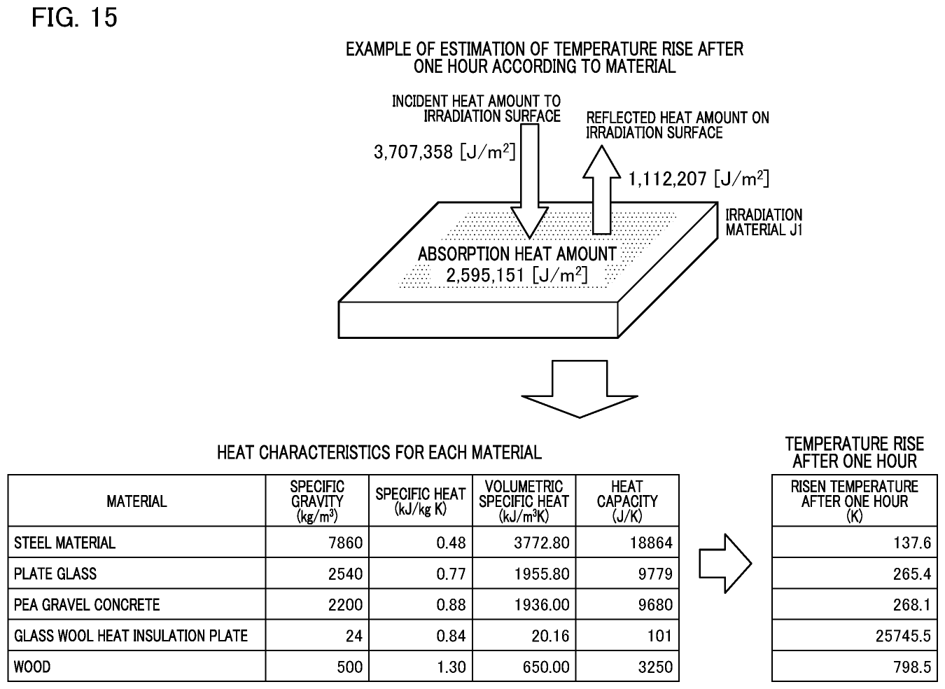

FIG. 15 is a diagram illustrating an example of estimation of a temperature rise after one hour according to materials. When sunlight having a heat amount of 3,707,358 [J/m²] is incident on the irradiation material J1 in which the reflectance of the irradiation surface J2 is 30%, the reflection heat amount on the irradiation surface J2 is 1,112,207 [J/m²], and the absorption heat amount of the irradiation material J1 is 2,595,151 [J/m²]. Considering the heat characteristics for each material illustrated in FIG. 15, the temperature rise after one hour for each material can be estimated as illustrated in FIG. 15. For example, when the material of the irradiation material J1 is a steel material, since the heat capacity is 18864 [J/K], the heat amount received in one hour is 2595.151 [J/m2]×1 [m²]/18864 [J/K]=137.6 [K]. Therefore, the temperature of the steel material initially at 20 [° C.] rises as follows after one hour: 20 [° C.]+137.6 [K]=157.6 [° C.]. Similarly, the temperature of a glass wool heat insulation plate initially at 20 [° C.] rises as follows: 20 [° C.]+25745.5 [K]=25765.5 [° C.]. Note that, here, it is assumed that the shape of the material model of the irradiation material J1 is 1 m×1 m×5 mm thickness. In addition, this estimation is an estimation in a case where it is assumed that there is no heat dissipation (heat radiation, heat conduction, heat transfer, or the like) from the irradiation material J1. Actually, since there is heat dissipation from the irradiation material J1, the temperature does not rise so much. In the estimation, it is sufficient if heat dissipation is taken into consideration as necessary. According to this estimation, it is possible to predict a temperature rise in an irradiation surface of a structure, land, or the like, which has been difficult to measure due to a high location or difficulty of approach by a person, and according to the present example, it is possible to use the prediction for predicting deterioration of the structure or for a forest tree planting plan.

### Example 5

<Entry of Reflection on Another Irradiation Surface (Example of Sidewalk)>

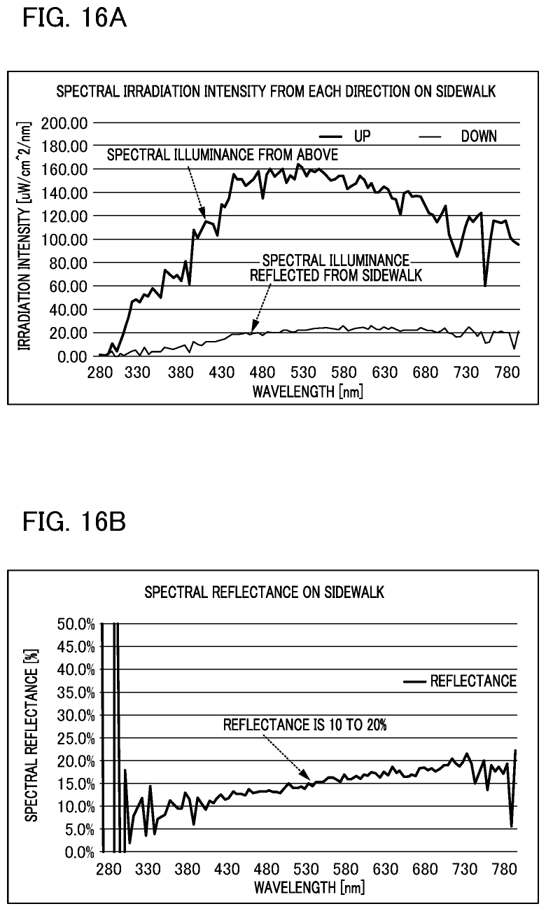

In the present example, in the configuration illustrated in FIG. 1, the sunlight information provision system 10 can calculate the reflection energy on the basis of the reflectance of a sidewalk and calculate the irradiation amount emitted to the irradiation surface. The reflectance of the sidewalk can be obtained by, for example, the method described with reference to FIGS. 7(a) and 7(b). FIG. 16(a) is a graph illustrating an example of spectral irradiation intensity from each direction on a sidewalk. In FIG. 16(a), the horizontal axis is the wavelength of light, and the vertical axis is irradiation intensity. FIG. 16(b) is a graph illustrating an example of spectral reflectance on a sidewalk. In FIG. 16(b), the horizontal axis is the wavelength of light, and the vertical axis is spectral reflectance. Referring to FIG. 16(b), it can be seen that the spectral reflectance of the sidewalk is 10 to 20%.

### Example 6

<Entry of Reflection on Another Irradiation Surface (Example of Grass Field, for Example, Turf)>

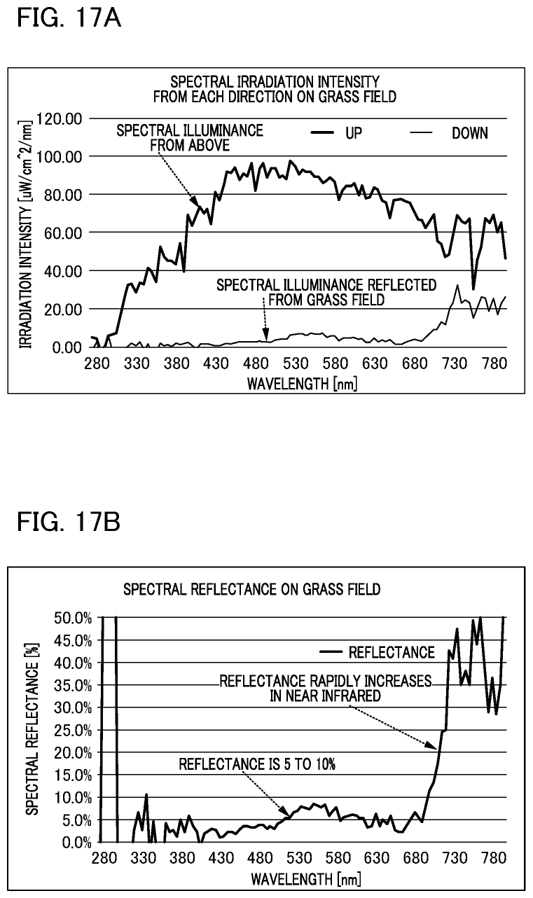

In the present example, in the configuration illustrated in FIG. 1, the sunlight information provision system 10 can calculate the reflection energy on the basis of the reflectance of a grass field and calculate the irradiation amount emitted to the irradiation surface. The reflectance of the grass field can be obtained by, for example, the method described with reference to FIGS. 7(a) and 7(b). FIG. 17(a) is a graph illustrating an example of spectral irradiation intensity from each direction on a grass field. In FIG. 17(a), the horizontal axis is the wavelength of light, and the vertical axis is irradiation intensity. FIG. 17(b) is a graph illustrating an example of spectral reflectance on a grass field. In FIG. 17(b), the horizontal axis is the wavelength of light, and the vertical axis is spectral reflectance. Referring to FIG. 17(b), it can be seen that the spectral reflectance of the grass field is 5 to 10%. In addition, referring to FIG. 17(b), it can be seen that the reflectance rapidly increases in near infrared in the grass field.

### Example 7

<Entry of Reflection on Another Irradiation Surface (Example of Asphalt)>

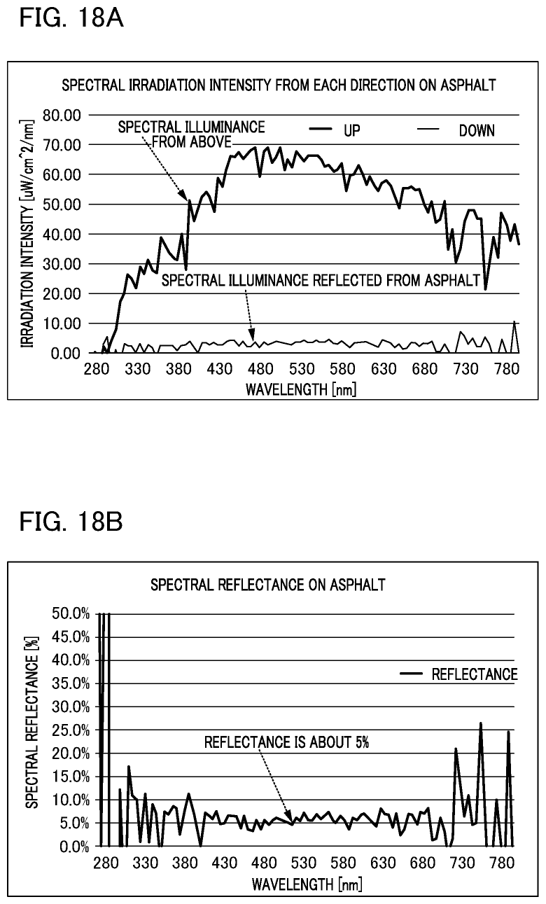

In the present example, in the configuration illustrated in FIG. 1, the sunlight information provision system 10 can calculate the reflection energy on the basis of the reflectance of asphalt and calculate the irradiation amount emitted to the irradiation surface. The reflectance of the asphalt can be obtained by, for example, the method described with reference to FIGS. 7(a) and 7(b). FIG. 18(a) is a graph illustrating an example of spectral irradiation intensity from each direction on asphalt. In FIG. 18(a), the horizontal axis is the wavelength of light, and the vertical axis is irradiation intensity. FIG. 18(b) is a graph illustrating an example of spectral reflectance on asphalt. In FIG. 18(b), the horizontal axis is the wavelength of light, and the vertical axis is spectral reflectance. Referring to FIG. 18(b), it can be seen that the spectral reflectance of the asphalt is 5%.

### Example 8

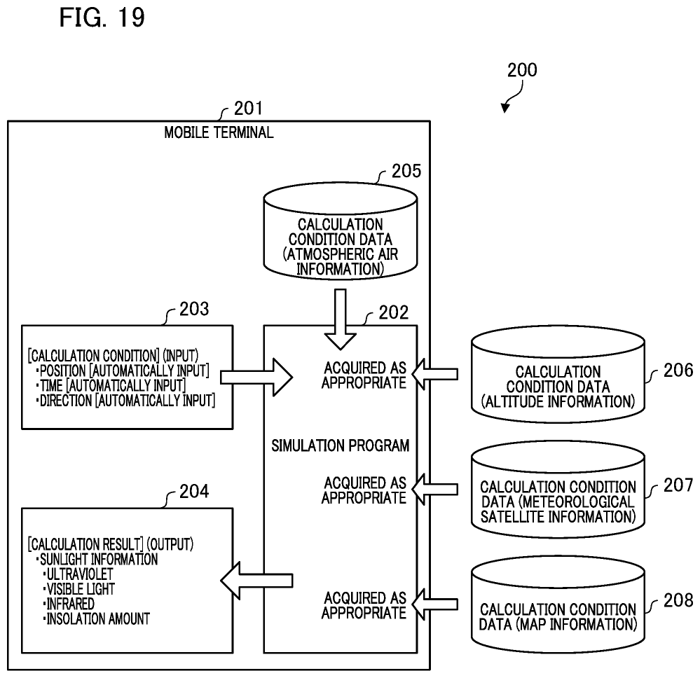

FIG. 19 is a block diagram illustrating a configuration of a sunlight information provision system according to Example 8 of the present invention. A sunlight information provision system 200 of the present example includes a mobile terminal 201 including a mobile terminal such as a smartphone, a PDA, or the like. PDA is an abbreviation for personal digital assistant. The mobile terminal 201 is an example of the information processing apparatus. In the present example, in the mobile terminal 201, the direction-specific sunlight intensity information described above is acquired and presented to the user.

The mobile terminal 201 includes a location information acquisition unit (for example, a GPS function unit) that automatically acquires the location information. The location information acquisition unit may acquire the location information by the user manually inputting the location information. The “position” included in a calculation condition 203 is input to a simulation program 202 by the location information acquisition unit.

The mobile terminal 201 includes a date-and-time information acquisition unit (for example, a built-in clock) that automatically acquires the date-and-time information. The date-and-time information acquisition unit may acquire the date-and-time information by the user manually inputting the date-and-time information. The “time” included in the calculation condition 203 is input to the simulation program 202 by the date-and-time information acquisition unit.

The mobile terminal 201 includes a direction information acquisition unit (for example, a built-in gyro sensor) that automatically acquires the direction information. The direction information acquisition unit may acquire the direction information by the user manually inputting the direction information. The “direction” included in the calculation condition 203 is input to the simulation program 202 by the direction information acquisition unit.

The mobile terminal 201 includes a storage unit 205 that stores atmospheric air information as calculation condition data. The mobile terminal 201 appropriately acquires altitude information from a storage unit 206 that stores altitude information as calculation condition data. The altitude information can be acquired from, for example, an API provided by the Ministry of Land, Infrastructure, Transport and Tourism. The mobile terminal 201 appropriately acquires meteorological satellite information from a storage unit 207 that stores meteorological satellite information as calculation condition data. The mobile terminal 201 appropriately acquires map information from a storage unit 208 that stores map information as calculation condition data. The mobile terminal 201 may acquire various types of information from the storage units 206, 207, and 208 in advance and operate offline, or may acquire various types of information from the storage units 206, 207, and 208 as necessary. The storage unit 205 that stores atmospheric air information may also be provided outside the mobile terminal 201, and the mobile terminal 201 may acquire atmospheric air information from the storage unit 205 as necessary. The mobile terminal 201 stores the date-and-time information that is information regarding date and time, the location information that is information regarding a location, and the sunlight intensity information that is information regarding sunlight intensity at the date and time indicated by the date-and-time information and the location indicated by the location information in association with each other. The mobile terminal 201 may store the date-and-time information that is information regarding date and time, the location information that is information regarding a location, the direction information that is information regarding a direction, and the direction-specific sunlight intensity information that is information regarding sunlight intensity at the date and time indicated by the date-and-time information, the location indicated by the location information, and in the direction indicated by the direction information in association with each other.

The mobile terminal 201 executes the simulation program 202. The simulation program 202 includes a first calculation unit that calculates the sunlight intensity information associated with the input calculation condition 203 (date-and-time information and location information). The simulation program 202 includes a second calculation unit that calculates the direction-specific sunlight intensity information using the result of calculation of the first calculation unit or using the input calculation condition 203 (direction information), the atmospheric air information, the altitude information, the meteorological satellite information, and the map information described above. Further, the simulation program 202 presents the direction-specific sunlight intensity information calculated by the second calculation unit to the user as a calculation result 204. The calculation result 204 includes sunlight information. The sunlight information includes information regarding ultraviolet light, information regarding visible light, information regarding infrared light, and information regarding an insolation amount. The simulation program 202 includes the first calculation unit that calculates the sunlight intensity information associated with the input calculation condition 203 (date-and-time information, location information, and direction information), and may include the second calculation unit that calculates the direction-specific sunlight intensity information using the result of calculation of the first calculation unit or using the atmospheric air information, the altitude information, the meteorological satellite information, and the map information described above.

According to the present example, by automatically acquiring the calculation condition 203 by the mobile terminal 201, input conditions such as date and time, location, and direction can be prepared at the same time, and the direction-specific sunlight intensity information according to the input conditions can be calculated. According to the present example, the date-and-time information can be acquired by the built-in clock, the location information can be acquired by the built-in GPS function, and for the direction information, the mobile terminal 201 is caused to face in a desired direction and the facing direction can be acquired by the built-in gyro sensor, and therefore each piece of information can be acquired at the same timing.

### Example 9

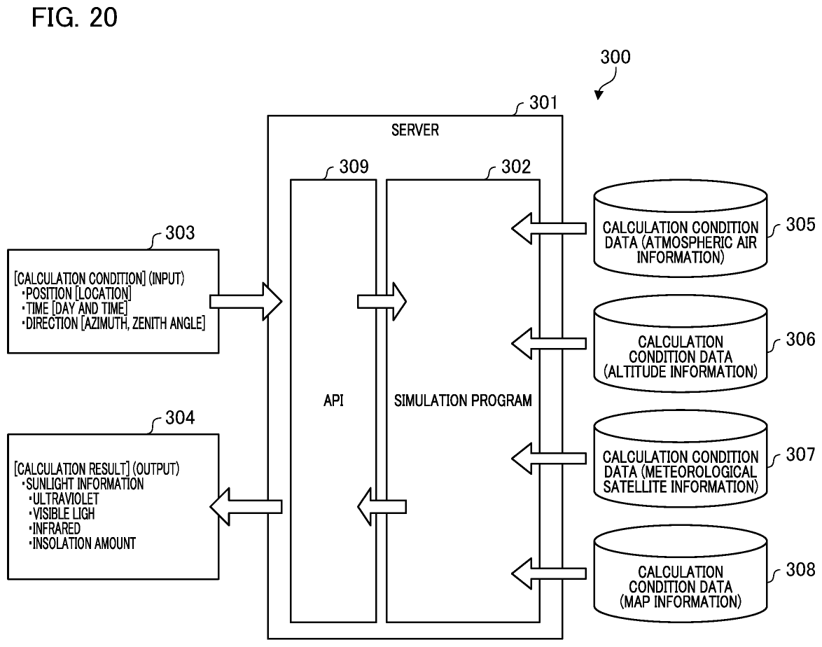

FIG. 20 is a block diagram illustrating a configuration of a sunlight information provision system according to Example 9 of the present invention. A sunlight information provision system 300 of the present example includes a server 301. In the present example, the server 301 acquires the direction-specific sunlight intensity information described above, and provides the direction-specific sunlight intensity information to an external application operating outside the server 301 via an API 309. API is an abbreviation for application programming interface. The API 309 may be, for example, a web API. Web is an abbreviation of world wide web. The server 301 is an example of the information processing apparatus. In the present example, for example, the API 309 is provided on a cloud, and sunlight information is provided by being called from other various APIs or applications. The sunlight information provision system 300 may store and accumulate a calculation condition 303 input via the API 309, and collectively calculate the direction-specific sunlight intensity information by a simulation program 302. At this time, integration calculation in which a period such as one day or one year is set may be performed.

The server 301 includes the API 309. The API 309 receives an input of the calculation condition 303 from the external application, and outputs a calculation result 304 to the external application. The calculation condition 303 includes “position” corresponding to the location information. The calculation condition 303 includes “time” corresponding to the date-and-time information. The calculation condition 303 includes “direction” corresponding to the direction information.

The API 309 receives an input of the calculation condition 303 from the external application (for example, receives via a network) and passes the input to the simulation program 302. The server 301 has the simulation program 302.

The server 301 acquires atmospheric air information from a storage unit 305 that stores atmospheric air information as calculation condition data. The server 301 acquires altitude information from a storage unit 306 that stores altitude information as calculation condition data. The server 301 acquires meteorological satellite information from a storage unit 307 that stores meteorological satellite information as calculation condition data. The server 301 acquires map information from a storage unit 308 that stores map information as calculation condition data. The server 301 stores the date-and-time information that is information regarding date and time, the location information that is information regarding a location, and the sunlight intensity information that is information regarding sunlight intensity at the date and time indicated by the date-and-time information and the location indicated by the location information in association with each other.

The server 301 executes the simulation program 302. The simulation program 302 includes a first calculation unit that calculates the sunlight intensity information associated with the input calculation condition 303. The simulation program 302 includes a second calculation unit that calculates the direction-specific sunlight intensity information using the result of calculation of the first calculation unit or using the atmospheric air information, the altitude information, the meteorological satellite information, and the map information described above. Further, the simulation program 302 provides (for example, transmits via a network) the direction-specific sunlight intensity information calculated by the second calculation unit to the external application via the API 309 as the calculation result 304. The calculation result 304 includes sunlight information. The sunlight information includes information regarding ultraviolet light, information regarding visible light, information regarding infrared light, and information regarding an insolation amount.

### Example 10

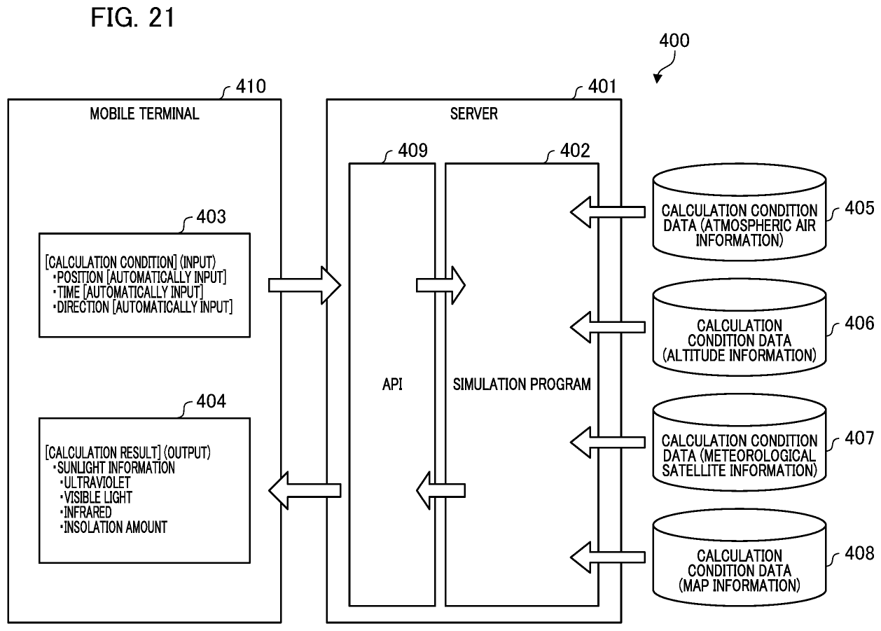

FIG. 21 is a block diagram illustrating a configuration of a sunlight information provision system according to Example 10 of the present invention. A sunlight information provision system 400 of the present example includes a server 401. In the present example, the server 401 acquires the direction-specific sunlight intensity information described above, and provides the direction-specific sunlight intensity information to an external application operating outside the server 401 via an API 409. The API 409 may be, for example, a web API. The server 401 is an example of the information processing apparatus. In the present example, the external application operates on a mobile terminal 410 such as a smartphone, a PDA, or the like. The mobile terminal 410 is an example of the information processing apparatus. The sunlight information provision system 400 may store and accumulate a calculation condition 403 input via the API 409, and collectively calculate the direction-specific sunlight intensity information by a simulation program 402. At this time, integration calculation in which a period such as one day or one year is set may be performed.

The mobile terminal 410 includes a location information acquisition unit (for example, a GPS function unit) that automatically acquires the location information. The location information acquisition unit may acquire the location information by the user manually inputting the location information. The “position” included in the calculation condition 403 is acquired by the location information acquisition unit and input to the simulation program 402 via the API 409.

The mobile terminal 410 includes a date-and-time information acquisition unit (for example, a built-in clock) that automatically acquires the date-and-time information. The date-and-time information acquisition unit may acquire the date-and-time information by the user manually inputting the date-and-time information. The “time” included in the calculation condition 403 is acquired by the date-and-time information acquisition unit and input to the simulation program 402 via the API 409.

The mobile terminal 410 includes a direction information acquisition unit (for example, a built-in gyro sensor) that automatically acquires the direction information. The direction information acquisition unit may acquire the direction information by the user manually inputting the direction information. The “direction” included in the calculation condition 403 is acquired by the direction information acquisition unit and input to the simulation program 402 via the API 409.

The server 401 includes the API 409. The API 409 receives an input of the calculation condition 403 from the external application operating on the mobile terminal 410, and outputs a calculation result 404 to the external application. The calculation condition 403 includes “position” corresponding to the location information. The calculation condition 403 includes “time” corresponding to the date-and-time information. The calculation condition 403 includes “direction” corresponding to the direction information.

The API 409 receives an input of the calculation condition 403 from the external application (for example, receives via a network) and passes the input to the simulation program 402. The server 401 has the simulation program 402.

The server 401 acquires atmospheric air information from a storage unit 405 that stores atmospheric air information as calculation condition data. The server 401 acquires altitude information from a storage unit 406 that stores altitude information as calculation condition data. The server 401 acquires meteorological satellite information from a storage unit 407 that stores meteorological satellite information as calculation condition data. The server 401 acquires map information from a storage unit 408 that stores map information as calculation condition data. The server 401 stores the date-and-time information that is information regarding date and time, the location information that is information regarding a location, and the sunlight intensity information that is information regarding sunlight intensity at the date and time indicated by the date-and-time information and the location indicated by the location information in association with each other.

The server 401 executes the simulation program 402. The simulation program 402 includes a first calculation unit that calculates the sunlight intensity information associated with the input calculation condition 403. The simulation program 402 includes a second calculation unit that calculates the direction-specific sunlight intensity information using the result of calculation of the first calculation unit or using the atmospheric air information, the altitude information, the meteorological satellite information, and the map information described above. Further, the simulation program 402 provides (for example, transmits via a network) the direction-specific sunlight intensity information calculated by the second calculation unit to the external application operating on the mobile terminal 410 via the API 409 as the calculation result 404. The calculation result 404 includes sunlight information. The sunlight information includes information regarding ultraviolet light, information regarding visible light, information regarding infrared light, and information regarding an insolation amount.

### Example 11

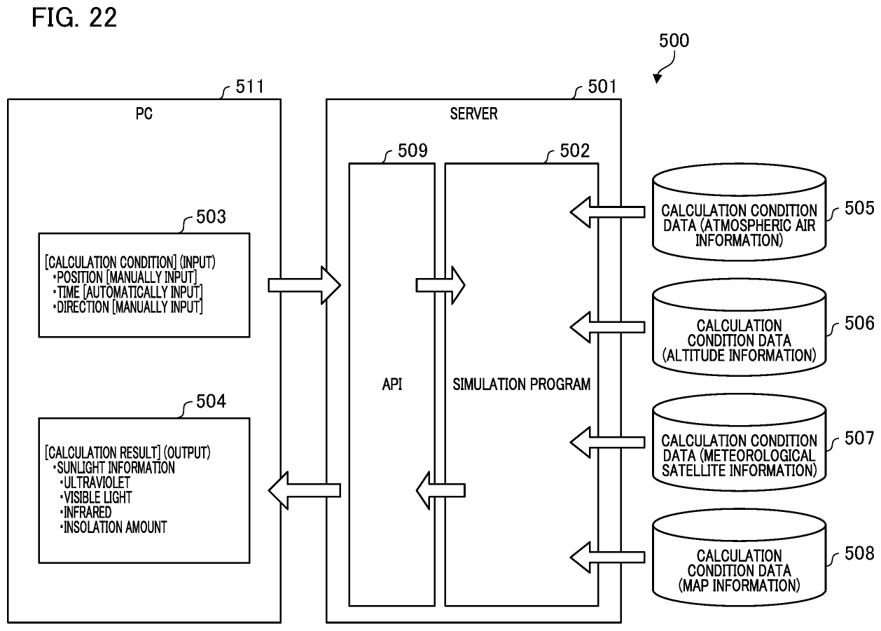

FIG. 22 is a block diagram illustrating a configuration of a sunlight information provision system according to Example 11 of the present invention. A sunlight information provision system 500 of the present example includes a server 501. In the present example, the server 501 acquires the direction-specific sunlight intensity information described above, and provides the direction-specific sunlight intensity information to an external application operating outside the server 501 via an API 509. The API 509 may be, for example, a web API. The server 501 is an example of the information processing apparatus. In the present example, the external application operates on a PC 511. PC is an abbreviation for personal computer. The PC 511 is an example of the information processing apparatus.

The PC 511 includes the location information acquisition unit that acquires the location information by the user manually inputting the location information. The location information acquisition unit may automatically acquire the location information (for example, a GPS function unit). The “position” included in a calculation condition 503 is acquired by the location information acquisition unit and input to a simulation program 502 via the API 509.

The PC 511 includes a date-and-time information acquisition unit (for example, a built-in clock) that automatically acquires the date-and-time information. The date-and-time information acquisition unit may acquire the date-and-time information by the user manually inputting the date-and-time information. The “time” included in the calculation condition 503 is acquired by the date-and-time information acquisition unit and input to the simulation program 502 via the API 509.

The PC 511 includes the direction information acquisition unit that acquires the direction information by the user manually inputting the direction information. The direction information acquisition unit may automatically acquire the direction information (for example, a built-in gyro sensor). The “direction” included in the calculation condition 503 is acquired by the direction information acquisition unit and input to the simulation program 502 via the API 509.

The server 501 includes the API 509. The API 509 receives an input of the calculation condition 503 from the external application operating on the PC 511, and outputs a calculation result 504 to the external application. The calculation condition 503 includes “position” corresponding to the location information. The calculation condition 503 includes “time” corresponding to the date-and-time information. The calculation condition 503 includes “direction” corresponding to the direction information.

The API 509 receives an input of the calculation condition 503 from the external application (for example, receives via a network) and passes the input to the simulation program 502. The server 501 has the simulation program 502.

The server 501 acquires atmospheric air information from a storage unit 505 that stores atmospheric air information as calculation condition data. The server 501 acquires altitude information from a storage unit 506 that stores altitude information as calculation condition data. The server 501 acquires meteorological satellite information from a storage unit 507 that stores meteorological satellite information as calculation condition data. The server 501 acquires map information from a storage unit 508 that stores map information as calculation condition data. The server 501 stores the date-and-time information that is information regarding date and time, the location information that is information regarding a location, and the sunlight intensity information that is information regarding sunlight intensity at the date and time indicated by the date-and-time information and the location indicated by the location information in association with each other.

The server 501 executes the simulation program 502. The simulation program 502 includes a first calculation unit that calculates the sunlight intensity information associated with the input calculation condition 503. The simulation program 502 includes a second calculation unit that calculates the direction-specific sunlight intensity information using the result of calculation of the first calculation unit or using the atmospheric air information, the altitude information, the meteorological satellite information, and the map information described above. Further, the simulation program 502 provides (for example, transmits via a network) the direction-specific sunlight intensity information calculated by the second calculation unit to the external application operating on the PC 511 via the API 509 as the calculation result 504. The calculation result 504 includes sunlight information. The sunlight information includes information regarding ultraviolet light, information regarding visible light, information regarding infrared light, and information regarding an insolation amount.

Although the preferred embodiments of the present invention have been described above, the present invention is not limited to these embodiments. The object of the present invention is also achieved by supplying a storage medium storing a program code (computer program) for realizing the functions of the above-described examples to a system or an apparatus, and reading and executing the program code stored in the storage medium by a computer of the system or apparatus to which the storage medium has been supplied. In this case, the program code itself read from the storage medium realizes the functions of the above-described examples, and the storage medium storing the program code constitutes the present invention. In addition, in the above-described embodiments, the computer executes the program to function as each processing unit, but a part or all of the processing may be configured by a dedicated electronic circuit (hardware). The present invention is not limited to the specific examples described above, and various modifications and changes can be made within the scope of the gist of the present invention described in the claims, including replacement of each configuration of each example. For example, the calculation result 504 may include the irradiation surface temperature.

The present application claims priority based on Japanese Patent Application No. 2019-173926 filed on Sep. 25, 2019, the entire contents of which are incorporated herein by reference.

### REFERENCE SIGNS LIST

2, 3 Client machine
4 Network
10 Sunlight information provision system
11 First calculation unit
12 Second calculation unit
13 Storage unit
17 Communication unit

1. A sunlight information provision system comprising:
a storage unit that stores date-and-time information that is information regarding date and time, location information that is information regarding a location, and sunlight intensity information that is information regarding sunlight intensity at date and time indicated by the date-and-time information and location indicated by the location information in association with each other;
a date-and-time information acquisition unit that acquires the date-and-time information;
a location information acquisition unit that acquires the location information;
a direction information acquisition unit that acquires the direction information;
a first calculation unit that calculates the sunlight intensity information associated with sunlight inquiry information including the date-and-time information acquired by the date-and-time information acquisition unit, the location information acquired by the location information acquisition unit, and the direction information acquired by the direction information acquisition unit;
a second calculation unit that calculates direction-specific sunlight intensity information by using a result of calculation of the first calculation unit; and
a presentation unit that presents the direction-specific sunlight intensity information calculated by the second calculation unit to a user.

2. A sunlight information provision system comprising:
a storage unit that stores date-and-time information that is information regarding date and time, location information that is information regarding a location, and sunlight intensity information that is information regarding sunlight intensity at date and time indicated by the date-and-time information and location indicated by the location information in association with each other;
an API that is an interface for an external program that is a program executed by an external apparatus;
a first calculation unit that calculates the sunlight intensity information associated with sunlight inquiry information input via the API; and
a second calculation unit that calculates direction-specific sunlight intensity information by using a result of calculation of the first calculation unit, wherein
the sunlight inquiry information includes the date-and-time information, the location information, and direction information indicating a direction in which an irradiation surface receiving irradiation of sunlight faces,
the direction-specific sunlight intensity information is information including intensity of sunlight received by an irradiation surface indicated by the direction information at date and time indicated by the date-and-time information and a location indicated by the location information,
the API receives the sunlight inquiry information transmitted from the external program, and
the API transmits the direction-specific sunlight intensity information calculated by the second calculation unit to the external program that is a transmission source of the sunlight inquiry information.

3. An information processing apparatus comprising:
a date-and-time information acquisition unit that acquires the date-and-time information;
a location information acquisition unit that acquires the location information;
a direction information acquisition unit that acquires the direction information;
a transmission unit that transmits the date-and-time information acquired by the date-and-time information acquisition unit, the location information acquired by the location information acquisition unit, and the direction information acquired by the direction information acquisition unit to the sunlight information provision system according to claim 2; and
a reception unit that receives the direction-specific sunlight intensity information from the sunlight information provision system according to transmission of the date-and-time information, the location information, and the direction information by the transmission unit.

4. The information processing apparatus according to claim 3, comprising:
a date-and-time information reception unit that receives an input of the date-and-time information by a user; and
a direction information reception unit that receives an input of the direction information by the user, wherein
the date-and-time information acquisition unit acquires the date-and-time information the input of which has been received by the date-and-time information reception unit, and
the direction information acquisition unit acquires the direction information the input of which has been received by the direction information reception unit.

5. A sunlight information provision program causing a computer to function as:
a storage unit that stores date-and-time information that is information regarding date and time, location information that is information regarding a location, and sunlight intensity information that is information regarding sunlight intensity at date and time indicated by the date-and-time information and location indicated by the location information in association with each other;
a date-and-time information acquisition unit that acquires the date-and-time information;
a location information acquisition unit that acquires the location information;
a direction information acquisition unit that acquires the direction information;
a first calculation unit that calculates the sunlight intensity information associated with sunlight inquiry information including the date-and-time information acquired by the date-and-time information acquisition unit, the location information acquired by the location information acquisition unit, and the direction information acquired by the direction information acquisition unit;
a second calculation unit that calculates direction-specific sunlight intensity information by using a result of calculation of the first calculation unit; and
a presentation unit that presents the direction-specific sunlight intensity information calculated by the second calculation unit to a user.
